(19) United States
(12) Patent Application Publication
(10) Pub. No.: US 2026/0112295 A1
(43) Pub. Date: Apr. 23, 2026

(54) CLEAR THERMOCHROMIC THERAPEUTIC ULTRASOUND PHANTOM

(71) Applicant: Fus Mobile Inc., Alpharetta, GA (US)

(72) Inventors: Ari HANANEL, Alpharetta, GA (US); Ron AGINSKY, Haifa (IL); Brian SKOGLIND, Greenville, SC (US)

(73) Assignee: Fus Mobile Inc., Alpharetta, GA (US)

(21) Appl. No.: 19/361,447

(22) Filed: Oct. 17, 2025

Related U.S. Application Data
(60) Provisional application No. 63/708,420, filed on Oct. 17, 2024.

(51) Int. Cl. G09B 23/30

(52) U.S. Cl. CPC G09B 23/306

(57) ABSTRACT

A transparent phantom for simulating tissue response to high-intensity focused ultrasound (HIFU). The phantom includes an embedding material that is both optically and acoustically transparent, a bone element embedded within the material, and a thermochromic coating on the bone element that changes color when heated above a threshold temperature. The phantom provides real-time visual feedback of thermal effects for training and system validation

### CROSS REFERENCE TO RELATED APPLICATIONS

This application claims the benefit of U.S. Provisional Patent Application No. 63/708,420 filed Oct. 17, 2024, which is incorporated by reference.

### BACKGROUND AND RELATED TECHNOLOGY

The technology relates generally to medical training and system validation devices, and more particularly to phantoms configured to simulate tissue response to high-intensity focused ultrasound (HIFU) systems.

High-intensity focused ultrasound (HIFU) systems are utilized in both therapeutic and diagnostic applications. Accurate targeting and precise energy delivery are essential for safe and effective operation. Conventional HIFU phantoms are typically opaque and provide only indirect thermal feedback through external thermometers or imaging modalities such as magnetic resonance imaging (MRI) thermometry.

To date there has not been offered a reusable, optically transparent phantom that enables direct visual observation of thermal effects during HIFU operation, while maintaining acoustic properties similar to those of biological tissue.

### SUMMARY OF THE TECHNOLOGY

Some embodiments of the present technology may provide a device for simulating tissue response to high-intensity focused ultrasound (HIFU), which may include: an embedding material at least partly transmissive to light in the visible light range and at least partly transmissive to acoustic waves in the ultrasound range, a bone element embedded within the embedding material, and a coating disposed on at least a portion of the bone element, the coating comprising thermochromic paint that changes color when heated above a predetermined temperature threshold.

In some embodiments, the embedding material comprises a solid or semi-solid optically transparent gel.

In some embodiments, the embedding material is both acoustically and optically transparent to permit simultaneous ultrasound transmission and visual observation.

In some embodiments, the bone element comprises a material selected from the group consisting of rigid polyvinyl chloride (PVC), polyurethane resin, and real bone.

In some embodiments, the bone element is positioned at a predetermined depth within the embedding material to simulate a specific anatomical region.

In some embodiments, the thermochromic paint changes color from an opaque color to a transparent color when heated above the predetermined temperature threshold.

In some embodiments, the thermochromic paint changes color from a first visible color to a second visible color when heated above the predetermined temperature threshold.

In some embodiments, the thermochromic paint has a temperature threshold corresponding to a physiologically relevant heating range. A predetermined temperature for color transition of the thermochromic paint may be a temperature that is generated in the relevant area by an ultrasound treatment, imaging and/or diagnostic procedure, such as a HIFU treatment or procedure that causes a thermochromic paint to visibly change color or become transparent

In some embodiments, the phantom may be imaged using different imaging modalities including ultrasound, X-ray, computed tomography (CT), and magnetic resonance imaging (MRI). The gel may be modified to interact better with different imaging modalities, for example to more closely approximate the responses of human tissue, such as by adding one or more dopants or components to change density of the gel.

In some embodiments, the phantom is reusable after cooling to ambient temperature.

In some embodiments, the device includes anatomical landmarks marked on the bone element prior to coating with the thermochromic paint.

In some embodiments, the embedding material and bone element are contained within a transparent housing configured to maintain shape and prevent dehydration of the gel.

In some embodiments, the phantom comprises a radio-opaque marker embedded within the embedding material to facilitate X-ray targeting.

In some embodiments, the embedding material maintains transparency and elasticity after repeated heating and cooling cycles.

In some embodiments, the embedding material comprises water.

In some embodiments, the embedding material comprises a mixture of transparent gel and water to adjust acoustic impedance. Incorporating different amounts of water into the gel matrix, may lower the overall impedance to more closely match that of biological tissue, thereby improving ultrasound transmission and minimizing reflection at interfaces. Thus, adjusting the gel-water ratio may cause the phantom to emulate the acoustic behavior of human tissue while maintaining clear visual observation for HIFU training and validation.

In some embodiments, the device includes a sheet of thermochromic material disposed adjacent to the bone element.

In some embodiments, the phantom is configured to be mounted within a container having a removable closure for replacement of the embedding material.

In some embodiments, the phantom is configured to be stored in a sealed container to prevent dehydration of the embedding material.

In some embodiments, the embedding material remains stable under ambient storage conditions for at least twelve months. In embodiments, the embedding material may include additives and stabilizers for this purpose. Additives may include for example humectants such as glycerol or propylene glycol to reduce vapor loss. Stabilizers may include, without limitations a biocide.

In some embodiments, the thermochromic paint is selected to change color reversibly upon cooling below the predetermined temperature threshold. The properties and transition points of such thermochromic paint are generally made available by the manufacture so that selection of an appropriate thermochromic paint is within the skill of the ordinary artisan

In some embodiments, the thermochromic paint exhibits a color transition within a few seconds of reaching the predetermined temperature threshold.

In some embodiments, the device includes a temperature sensor embedded adjacent to the bone element for calibration of the thermochromic response.

The technology may also be embodied as a method for using the phantom device to simulate tissue response to high-intensity focused ultrasound (HIFU), comprising: providing a bone or bone model embedded within an optically transparent embedding material transmissive to acoustic waves in the ultrasound range; the bone or bone model having a thermochromic material applied thereon that changes color when heated above a predetermined temperature threshold; and applying acoustic waves from outside the embedding material to the bone or bone model causing the thermochromic paint to change color. Other methods of using the phantom described herein will be readily apparent to the person skilled in the art from the description of the device herein.

### BRIEF DESCRIPTION OF THE DRAWINGS

For a better understanding of embodiments of the technology and to show how the same can be carried into effect, reference is made, purely by way of example, to the accompanying drawings in which like numerals designate corresponding elements or sections throughout. In the accompanying drawings:

FIG. 1 is a side-view photograph of the thermochromic-painted spine embedded within an optically transparent acoustic gel;

FIG. 2 is a side-view photograph of the phantom after being heated in one location, illustrating the color change of the thermochromic material;

FIG. 3 comprises two X-ray images of the anatomy embedded within the transparent phantom.

### DETAILED DESCRIPTION OF THE TECHNOLOGY

In the following description, various aspects of the present technology are described. For purposes of explanation, specific configurations and details are set forth in order to provide a thorough understanding of the present technology. However, it will also be apparent to one skilled in the art that the present technology can be practiced without the specific details presented herein. Furthermore, well known features can have been omitted or simplified in order not to obscure the present technology. With specific reference to the drawings, it is stressed that the particulars shown are by way of example and for purposes of illustrative discussion of the present technology only and are presented in the cause of providing what is believed to be the most useful and readily understood description of the principles and conceptual aspects of the technology. In this regard, no attempt is made to show structural details of the technology in more detail than is necessary for a fundamental understanding of the technology, the description taken with the drawings making apparent to those skilled in the art how the several forms of the technology can be embodied in practice.

Before at least one embodiment of the technology is explained in detail, it is to be understood that the technology is not limited in its application to the details of construction and the arrangement of the components set forth in the following description or illustrated in the drawings. The technology is applicable to other embodiments that can be practiced or carried out in various ways as well as to combinations of the disclosed embodiments. Also, it is to be understood that the phraseology and terminology employed herein is for the purpose of description and should not be regarded as limiting.

Embodiments of the present technology may improve devices for simulating tissue response to high-intensity focused ultrasound (HIFU).

Embodiments of the present technology may provide an optically transparent HIFU phantom including an embedded bone element, which may be a real bone specimen, a polyurethane resin bone model, or a rigid polyvinyl chloride (PVC) bone model. The bone element may include selected anatomical landmarks drawn on its surface and may be coated with a thermochromic paint. The phantom may be used in clinician training, system functioning and accuracy validation testing, as well as for marketing or educational demonstrations. The thermochromic paint may change color when heated above a specified temperature threshold, thereby providing a visible indication of the heating location. In embodiments, and not by way of limitation, a relevant heating range for use with a HIFU system may be 20° C. to 70° C.

The color change may either reveal the underlying bone structure or indicate the targeted region. The embedding material may be both acoustically and optically transparent to permit simultaneous ultrasound transmission and visual observation. During operation, the phantom may allow a user to observe heat-induced color changes in real time while practicing targeting, performing system validation, or demonstrating a therapeutic focused ultrasound system. Targeting may be performed using imaging modalities such as ultrasound, X-ray, computed tomography (CT), or magnetic resonance imaging (MRI). The phantom's gel material maintains its structural integrity over time, retains its shape, lacks odor, and resists drying under normal storage conditions. The phantom may provide immediate and direct visual feedback of heating effects due to its transparency and thermochromic coating. Embodiments of the technology may also utilize the same gel or water medium in combination with a sheet of thermochromic material, a radio-opaque target, and a container to form a daily quality assurance (DQA) setup for system calibration.

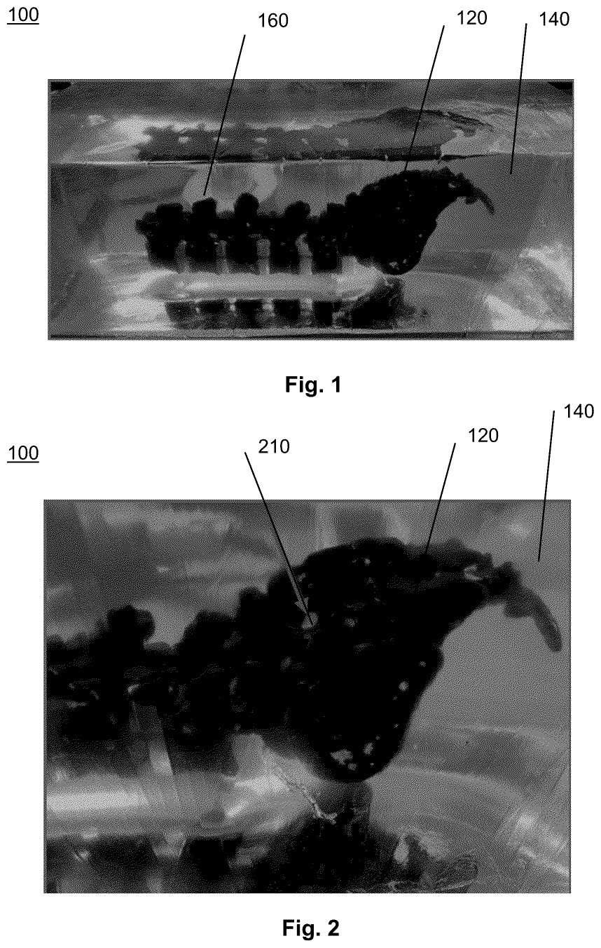

Reference is made to FIG. 1, which is a side-view photograph of a thermochromic-painted spine embedded in an optically transparent acoustic gel.

Embodiments of the present technology may provide an optically transparent high-intensity focused ultrasound (HIFU) phantom 100, including a bone element 120 embedded within an embedding gel material 140. The gel material 140 may comprise a clear, 100% synthetic, and reusable gelatin substitute formulated to replicate the density and resistance of human tissue for ballistic or acoustic testing. In one example, gel material 140 may be a commercially available product such as the synthetic ballistic gel sold by Clear Ballistics Corp. Routine experimentation with polymer concentrations and degree of polymer crosslinking in the gel may help to ensure stable optical and mechanical properties after repeated use.

The bone element 120 may be a real bone specimen, a polyurethane resin model, or a rigid polyvinyl chloride (PVC) bone model. In some embodiments, the bone model may be obtained from commercially available anatomical model suppliers, such as those offering human anatomy models under the Lvchen brand.

Selected anatomical landmarks may be marked or drawn on the surface of the bone element 120 prior to applying a thermochromic paint layer 160.

The thermochromic paint 160 may comprise a reversible temperature-sensitive coating that changes color when heated above a specified temperature threshold. For example, the thermochromic paint 160 may be a black-to-purple formulation having a transition temperature of approximately 95° F. (35° C.), such as that available from Atlanta Chemical Engineering. Other color-change formulations and temperature thresholds may also be used. The color change provides a visible indication of the heating location and may either reveal the underlying bone structure or indicate the targeted region. The embedding material is both acoustically and optically transparent to permit simultaneous ultrasound propagation and visual observation.

Reference is made to FIG. 2, which is a side view photograph of the phantom after being heated in one location, illustrating the color change of the thermochromic material. As shown in FIG. 2, when the phantom 100 may be exposed to focused ultrasound energy, a localized color change may appear on the coated bone element 120 at the region corresponding to the focal zone 210. This color change may provide immediate visual feedback of the heating location and relative intensity. The phantom may allow a user to observe heat-induced color changes in real time while practicing targeting, performing system validation, or demonstrating a therapeutic focused ultrasound system. Targeting may be performed using imaging modalities such as ultrasound, X-ray, computed tomography (CT), or magnetic resonance imaging (MRI).

The phantom may provide immediate and direct visual feedback of heating effects due to its optical transparency and thermochromic coating.

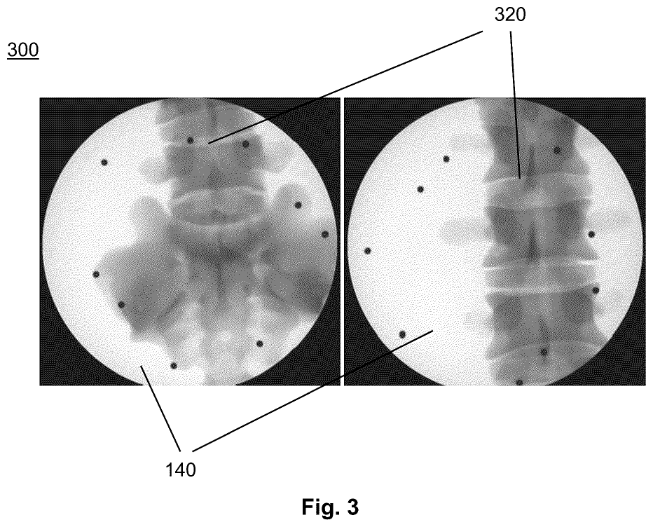

Reference is made to FIG. 3, which comprises two X-ray images of the anatomy embedded within the transparent phantom. The X-ray images demonstrate the visibility of the embedded bone structure 320 under radiographic imaging. The optical transparency of the embedding material 140 may allow the bone element and the thermochromic coating to be visualized simultaneously, confirming the phantom's compatibility with multiple imaging modalities.

In some embodiments of the current technology, the same gel or water medium may be used in combination with a sheet of thermochromic material, a radio-opaque target, and a container to form a daily quality assurance (DQA) setup for system calibration. The phantom may be reused after cooling to ambient temperature, while maintaining its optical and acoustic properties through repeated heating and cooling cycles.

In the above description, an embodiment is an example or implementation of the technology. The various appearances of “one embodiment”, “an embodiment”, “certain embodiments” or “some embodiments” do not necessarily all refer to the same embodiments. Although various features of the technology can be described in the context of a single embodiment, the features can also be provided separately or in any suitable combination. Conversely, although the technology can be described herein in the context of separate embodiments for clarity, the technology can also be implemented in a single embodiment. Certain embodiments of the technology can include features from different embodiments disclosed above, and certain embodiments can incorporate elements from other embodiments disclosed above. The disclosure of elements of the technology in the context of a specific embodiment is not to be taken as limiting their use in the specific embodiment alone. Furthermore, it is to be understood that the technology can be carried out or practiced in various ways and that the technology can be implemented in certain embodiments other than the ones outlined in the description above.

Although embodiments of the technology are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items.

The technology is not limited to those diagrams or to the corresponding descriptions. Meanings of technical and scientific terms used herein are to be commonly understood as by one of ordinary skill in the art to which the technology belongs, unless otherwise defined. While the technology has been described with respect to a limited number of embodiments, these should not be construed as limitations on the scope of the technology, but rather as exemplifications of some of the preferred embodiments. Other possible variations, modifications, and applications are also within the scope of the technology. Accordingly, the scope of the technology should not be limited by what has thus far been described, but by the appended claims and their legal equivalents.

1. A device for simulating tissue response to high-intensity focused ultrasound (HIFU), the device comprising:
an embedding material at least partly transmissive to light in the visible light range and at least partly transmissive to acoustic waves in the ultrasound range;
a bone element embedded within the embedding material; and
a coating disposed on at least a portion of the bone element, the coating comprising thermochromic paint that changes color when heated above a predetermined temperature threshold.

2. The device of claim 1, wherein the embedding material comprises a solid optically transparent gel.

3. The device of claim 1, wherein the bone element comprises a material selected from the group consisting of rigid polyvinyl chloride (PVC), polyurethane resin, and real bone.

4. The device of claim 1, wherein the bone element is positioned at a predetermined depth within the embedding material to simulate a specific anatomical region.

5. The device of claim 1, wherein the thermochromic paint changes color from an opaque color to a transparent color when heated above the predetermined temperature threshold.

6. The device of claim 1, wherein the thermochromic paint changes color from a first visible color to a second visible color when heated above the predetermined temperature threshold.

7. The device of claim 1, wherein the thermochromic paint has a temperature threshold corresponding to a physiologically relevant heating range.

8. The device of claim 1, wherein the phantom is configured for use with imaging modalities including ultrasound, X-ray, computed tomography (CT), and magnetic resonance imaging (MRI).

9. The device of claim 1, wherein the phantom is reusable after cooling to ambient temperature.

10. The device of claim 1, comprising anatomical landmarks marked on the bone element prior to coating with the thermochromic paint.

11. The device of claim 1, wherein the embedding material and bone element are contained within a transparent housing configured to maintain shape and prevent dehydration of the gel.

12. The device of claim 1, wherein the phantom comprises a radio-opaque marker embedded within the embedding material to facilitate X-ray targeting.

13. The device of claim 1, wherein the embedding material comprises a mixture of transparent gel and water to adjust acoustic impedance.

14. The device of claim 1, comprising a sheet of thermochromic material disposed adjacent to the bone element.

15. The device of claim 1, wherein the phantom is configured to be mounted within a container having a removable closure for replacement of the embedding material.

16. The device of claim 1, wherein the phantom is stored in a sealed container to prevent dehydration of the embedding material.

17. The device of claim 1, wherein the thermochromic paint is selected to change color reversibly upon cooling below the predetermined temperature threshold.

18. The device of claim 1, wherein the thermochromic paint exhibits a color transition within a few seconds of reaching the predetermined temperature threshold.

19. The device of claim 1, comprising a temperature sensor embedded adjacent to the bone element for calibration of the thermochromic response.

20. A method for simulating tissue response to high-intensity focused ultrasound (HIFU), the method comprising:
providing a bone or bone model embedded within an optically transparent embedding material transmissive to acoustic waves in the ultrasound range; the bone or bone model having a thermochromic material applied thereon that changes color when heated above a predetermined temperature threshold;
applying acoustic waves from outside the embedding material to the bone or bone model causing the thermochromic paint to change color.
